(19) United States
(12) Patent Application Publication
(10) Pub. No.: US 2018/0112126 A1
(43) Pub. Date: Apr. 26, 2018

(54) PARTICULATE-STABILIZED EMULSIONS FOR USE IN SUBTERRANEAN FORMATION OPERATIONS

(71) Applicant: Halliburton Energy Services, Inc., Houston, TX (US)

(72) Inventors: Yuming YANG, Houston, TX (US); Jimmie Dean WEAVER, JR., Duncan, OK (US); Dandan HU, Houston, TX (US); Linping KE, The Woodlands, TX (US)

(21) Appl. No.: 15/565,130

(22) PCT Filed: May 7, 2015
(86) PCT No.: PCT/US2015/029641

§ 371 Date: Oct. 6, 2017

(51) Int. Cl. C09K 8/92; C09K 8/70; C09K 8/57; C09K 8/575; C09K 8/565; C09K 8/58

(52) U.S. Cl. CPC C09K 8/92; C09K 8/70; C09K 8/572; C09K 2208/10; C09K 8/565; C09K 8/58; C09K 8/5751

(57) ABSTRACT

Methods including introducing a particulate-stabilized emulsion into a subterranean formation having a mineralogy profile, wherein the particulate-stabilized emulsion comprises: an external phase, an internal phase comprising a surfactant, and particulates at an interface between the internal phase and the external phase, thereby forming internal phase surfactant droplets surrounded with the particulates and suspended within the external phase, wherein at least a portion of the particulates are composed of a mineral-containing material selected to mimic at least a portion of the mineralogy profile of the subterranean formation; and destabilizing the particulate-stabilized emulsion to release the surfactant from the internal phase surfactant droplets.

### BACKGROUND

The present disclosure relates to subterranean formation operations and, more particularly, to particulate-stabilized emulsions for delivering surfactants to a downhole location during a subterranean formation operation.

Hydrocarbon producing wells (e.g., oil and gas wells) are typically formed by drilling a wellbore into a subterranean formation. A drilling fluid is circulated through a drill bit within the wellbore as the wellbore is being drilled. The drilling fluid is produced back to the surface of the wellbore with drilling cuttings for removal from the wellbore. The drilling fluid maintains a specific, balanced hydrostatic pressure within the wellbore, permitting all or most of the drilling fluid to be produced back to the surface.

After a wellbore is drilled, a cement column may be placed around a casing (or liner string) in the wellbore. In some instances, the cement column is formed by pumping a cement slurry through the bottom of the casing and out through an annulus between the outer casing wall and the formation face of the wellbore. The cement slurry then cures in the annular space, thereby forming a sheath of hardened cement that, inter alia, supports and positions the casing in the wellbore and bonds the exterior surface of the casing to the subterranean formation. This process is referred to as “primary cementing.” Among other things, the cement column may keep fresh water zones from becoming contaminated with produced fluids from within the wellbore, prevent unstable formations from caving in, and form a solid barrier to prevent fluid loss from the wellbore into the formation and the contamination of production zones with wellbore fluids.

Stimulation of subterranean formations may be performed using hydraulic fracturing treatments, for example. In hydraulic fracturing treatments, a treatment fluid is pumped into a portion of a subterranean formation at a rate and pressure such that the subterranean formation breaks down and one or more fractures are formed. Typically, solid particles are then deposited in the fractures. These solid particles, or “proppant,” serve to prevent the fractures from fully closing once the hydraulic pressure is removed by forming a proppant pack. As used herein, the term “proppant pack” refers to a collection of proppant in a fracture. By keeping the fracture from fully closing, the proppant aids in forming conductive paths through which fluids may flow.

In some cases, hydrocarbon production may be enhanced by supplementing typical stimulation operations with enhanced oil recovery (EOR) techniques. EOR techniques are used increase recovery of production fluids (e.g., hydrocarbons) by restoring formation pressure and improving fluid flow in the formation and typically involve injection of a substance that is not naturally occurring in a hydrocarbon-bearing formation. One EOR technique involves introducing a flooding composition into the subterranean formation in order to pressurize the formation and drive hydrocarbons toward one or more production wells. Such flooding compositions may be gas (e.g., carbon dioxide, natural gas, nitrogen, and the like), a thermal composition (e.g., steam, fire, and the like), and/or a chemical (e.g., surfactant, polymer, microbial, and the like), a supercritical liquid, for example. Another EOR technique is acidizing, in which an acid (e.g., hydrochloric acid) is injected into a subterranean formation in order to etch channels or create microfractures in the formation in order to enhance the conductivity of the fracture.

During many subterranean formation operations (e.g., drilling, cementing, hydraulic fracturing, EOR operations, and the like), surfactants may be used to enhance the performance of an operation. For example, surfactants may be used as wetting agents, foaming agents, detergents, dispersants, and the like. Accordingly, their use may be in various treatment fluids, such as those used in drilling, cementing, stimulation, EOR, wellbore cleaning, and the like. Surfactant adsorption into a subterranean formation (e.g., upon contact with a mineral surface) during placement and use of the surfactant, however, may occur thereby reducing the efficacy of the surfactant.

### BRIEF DESCRIPTION OF THE DRAWINGS

The following figures are included to illustrate certain aspects of the embodiments, and should not be viewed as exclusive embodiments. The subject matter disclosed is capable of considerable modifications, alterations, combinations, and equivalents in form and function, as will occur to those skilled in the art and having the benefit of this disclosure.

FIG. 1 schematically depicts a particulate-stabilized emulsion, according to one or more embodiments of the present disclosure.

FIG. 2 depicts a wellbore system for introducing a runner fluid into a formation for performing a tubular running operation, according to one or more embodiments of the present disclosure.

### DETAILED DESCRIPTION

The present disclosure relates to subterranean formation operations and, more particularly, to particulate-stabilized emulsions for delivering surfactants to a downhole location during a subterranean formation operation. As used herein, the term “particulate-stabilized emulsion” refers to an emulsion that is stabilized by solid particulates. The term “particulate-stabilized emulsion” and “pickering emulsion” are interchangeable and may be used as such herein.

Specifically, the particulate-stabilized emulsions described herein package surfactants for use in downhole operations for delivery to desired locations, while protecting the surfactant from adsorption into the surrounding formation. Traditional pickering emulsions utilize particulates to stabilize either oil-in-water or water-in-oil emulsions. The particulate-stabilized emulsions of the present disclosure, however, consist of internal phase surfactant droplets that are stabilized by particulates. The particulate-stabilized emulsions are highly resistant to coalescence, imparting stability and resistance to adsorption into subterranean formations. Moreover, the particulates are specifically selected for size and material to provide the desired stability to the emulsion depending on the particular subterranean formation operation being performed and when the surfactant is to be released from the particulate-stabilized emulsion in the formation.

It may be desirable that the particulates used in stabilizing the particulate-stabilized emulsions described herein are selected to comprise a material mimicking one or more of the minerals contained in the formation in which the surfactant is introduced. That is, the subterranean formation has a mineralogy profile that may be mimicked by one or more of the stabilizing particulates. This may be desirable because it may eliminate unfavorable interactions between the particulate-stabilized emulsion and the subterranean formation to which it is introduced. Additionally, using particulates that mimic the mineralogy profile of the subterranean formation may be desirable because superior formation compatibility may be realized. Such formation compatibility with the particulate-stabilized emulsions of the present disclosure may result in reduced or mitigated formation damage such that flow capacity of the formation is not reduced or significantly reduced. Accordingly, in some embodiments, the particulates may be composed of a variety of mineral-containing materials in combination to mimic one or all of the minerals in the mineralogy profile of the formation, or may be selected to mimic only the most prevalent mineral of the formation, or only several of the most prevalent minerals of the formation, without departing from the scope of the present disclosure.

One or more illustrative embodiments disclosed herein are presented below. Not all features of an actual implementation are described or shown in this application for the sake of clarity. It is understood that in the development of an actual embodiment incorporating the embodiments disclosed herein, numerous implementation-specific decisions must be made to achieve the developer's goals, such as compliance with system-related, lithology-related, business-related, government-related, and other constraints, which vary by implementation and from time to time. While a developer's efforts might be complex and time-consuming, such efforts would be, nevertheless, a routine undertaking for those of ordinary skill in the art having benefit of this disclosure.

It should be noted that when “about” is provided herein at the beginning of a numerical list, the term modifies each number of the numerical list. In some numerical listings of ranges, some lower limits listed may be greater than some upper limits listed. One skilled in the art will recognize that the selected subset will require the selection of an upper limit in excess of the selected lower limit. Unless otherwise indicated, all numbers expressing quantities of ingredients, properties such as molecular weight, reaction conditions, and so forth used in the present specification and associated claims are to be understood as being modified in all instances by the term “about.” As used herein, the term “about” encompasses +/−5% of a numerical value. Accordingly, unless indicated to the contrary, the numerical parameters set forth in the following specification and attached claims are approximations that may vary depending upon the desired properties sought to be obtained by the exemplary embodiments described herein. At the very least, and not as an attempt to limit the application of the doctrine of equivalents to the scope of the claim, each numerical parameter should at least be construed in light of the number of reported significant digits and by applying ordinary rounding techniques.

While compositions and methods are described herein in terms of “comprising” various components or steps, the compositions and methods can also “consist essentially of” or “consist of” the various components and steps. When “comprising” is used in a claim, it is open-ended.

As used herein, the term “substantially” means largely but not necessarily wholly.

In some embodiments, the present disclosure provides a method comprising introducing a particulate-stabilized emulsion into a subterranean formation. In some embodiments, the particulate-stabilized emulsion may be directed introduced into the subterranean formation for use in delivering the surfactant to a desired location in the formation. In other embodiments, the particulate-stabilized emulsion may be introduced into the subterranean formation in another treatment fluid (e.g., blended with another treatment fluid), such as a fracturing fluid, an acidizing fluid, and the like. Without limitation, the methods and compositions described herein may be used in any subterranean formation operation that may require controlled release of a surfactant. Such subterranean formation operations may include, but are not limited to, a stimulation operation, an acid-fracturing operation, a fracturing operation, an enhanced oil recovery operation (e.g., a surfactant flodding operation), a sand control operation, a fracturing operation, a frac-packing operation, a remedial operation, a well cleanout operation, a conformance control operation, an acidizing operation, and the like, and any combination thereof.

The subterranean formation into which the particulate-stabilized emulsion is introduced has a mineralogy profile. As used herein, the term “mineralogy profile” refers to one or more mineral composition(s) of a subterranean formation, and does not necessarily imply that every mineral be accounted for. For example, the mineralogy profile of a subterranean formation may be acquired by obtaining a near-wellbore core of the formation and performing a mineralogy study. Other mineralogy profiles may be achieved by performing a mineralogy study during drilling or another subterranean formation operation, by acquiring formation fluid (e.g., from a formation tester), during logging or wireline operations, and the like. Such mineralogy studies may use a variety of techniques to establish the mineralogy profile including, but not limited to, physical mineralogy, chemical mineralogy, optical mineralogy, crystallography, and the like. Specific mineralogy studies to establish the mineralogy profile may include, but are not limited to, x-ray diffraction, powder x-ray diffraction, and the like, and any combination thereof.

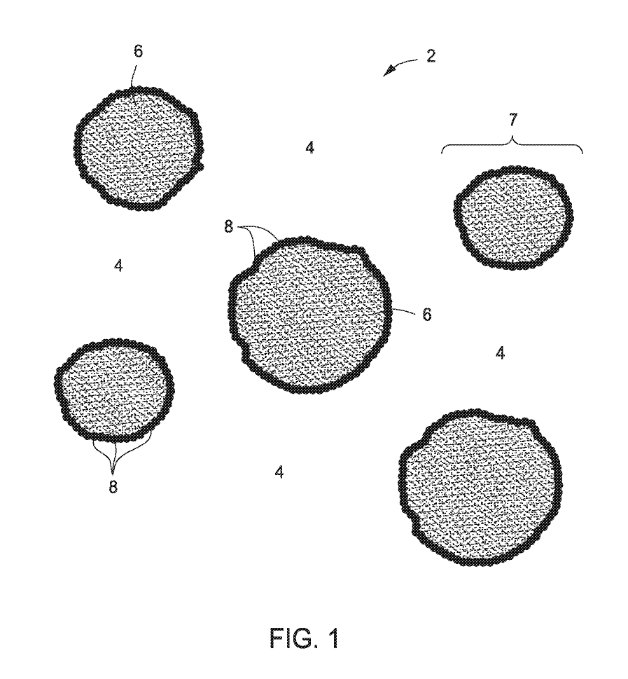

Referring now to FIG. 1, the particulate-stabilized emulsion 2 of the present disclosure may comprise an external phase 4, an internal phase 6 comprising a surfactant, and particulates 8 at the interface between the internal phase 6 and the external phase 4. Accordingly, the particulate-stabilized emulsion comprises internal phase surfactant droplets 7, which are characterized by the internal phase 6 surrounded by the particulates 8. The internal phase surfactant droplets thus may be suspended within the external phase of the particulate-stabilized emulsion. In some embodiments, the internal phase surfactant droplets may be present in an amount in the range of a lower limit of about 0.01%, 0.1%, 0.5%, 1%, 5%, 10%, 15%, 20%, 25%, and 30% to an upper limit of about 80%, 75%, 70%, 65%, 60%, 55%, 50%, 45%, 40%, 35%, and 30% by volume of the particulate-stabilized emulsion, encompassing any value and subset therebetween. In other embodiments, the internal phase surfactant droplets may be present from about 15% to about 60% by volume of the particulate-stabilized emulsion, or about 30% to about 40% by volume of the particulate-stabilized emulsion, encompassing any value and subset therebetween. Each of these is critical to the embodiments described herein, and the amount of internal phase surfactant droplets in the particulate-stabilized emulsion by volume may depend on the type of surfactant, the desired amount of surfactant, the particular subterranean formation operation, the composition of the particular subterranean formation being treated, and the like.

In some embodiments, the contact angle between the particulates and the internal phase (i.e., the particulates and the interphase of the internal phase) may be in the range of from a lower limit of about 30°, 40°, 50°, 60°, 70°, and 80° to an upper limit of about 130°, 120°, 110°, 100°, 90°, and 80°, encompassing any value and subset therebetween. In other embodiments, the contact angle between the particulates and the internal phase may be about 90°, without departing from the scope of the present disclosure.

In some embodiments, the particulates used in forming the particulate-stabilized emulsion of the present disclosure may be composed of a mineral-containing material selected to mimic at least a portion of the mineralogy profile of the subterranean formation. As used herein, the term “mineral-containing material” refers to a material having one or more minerals forming its composition. For example, the mineral-containing material of the present disclosure may be a ceramic, a glass, a polymer, a composite material thereof, and any combination thereof, wherein one or more minerals forms a portion of its composition. In other embodiments, the particulates may be formed from a mineral-containing material that is solely composed of one or more minerals, without departing from the scope of the present disclosure. In such a way, the particulates may mimic one or more mineral attributes of a mineralogy profile of a particulate subterranean formation. For example, the particulates may mimic 1, 2, 3, 4, 5, 6, 7, 8, 9, 10, or even more mineral attributes of a particular subterranean formation, without departing from the scope of the present disclosure. Generally, the particulates may be selected to mimic one or more minerals that form at least about 50%, at least about 60%, at least about 70%, at least about 80%, at least about 90%, or 100% of the mineralogy profile of the subterranean formation. It is also understood, that the mineral mimicked by the particulates may be an “attribute” of that mineral, such that it is a chemical component of the mineral. For example, the mineral in the subterranean formation may be a metal alloy, and only a subset of the metals forming the alloy are used to form the particulates for use in the particulate-stabilized emulsions of the present disclosure.

The particulates serve to surround or encase the internal phase surfactant droplets and prevent the surfactant from being miscible with the external phase of the particulate-stabilized emulsion. Accordingly, the particulates stabilize the internal phase surfactant droplets in the particulate-stabilized emulsion. By customizing the particulates to mimic at least a portion of the mineralogy profile of the subterranean formation, as discussed previously, formation compatibility may be enhanced. For example, in some embodiments, the subterranean formation may be a carbonate formation and at least a portion of the particulates in the particulate-stabilized emulsion are composed of calcium carbonate. As another example, in other embodiments, the subterranean formation may be a siliceous formation and at least a portion of the particulates in the particulate-stabilized emulsion are composed of silicon dioxide.

The design of the particulate-stabilized emulsions of the present disclosure permit the surfactants contained in the internal phase surfactant droplets to be placed deeper into wellbores over a period of time, withstand greater temperatures, withstand greater pressures, withstand greater shear stress (e.g., during pumping), and the like without destabilizing, while minimizing costs (e.g., the particulates are all that are required to stabilize the surfactant and they are relatively inexpensive). The particulates, both composition and size, discussed in greater detail below, may be used to fine tune the time period or location for destabilization, and release of the surfactant at a location or after a period of elapsed time in a subterranean formation. Destabilization may occur by disruption of the internal phase surfactant droplets to release the surfactants, which then may interact or otherwise contact the subterranean formation at a desired location. Such destabilization may occur simply by the elapse of time (which may be predicted or gauged by use of certain particulate material, sizes, and the like), exposure to certain temperatures (e.g., elevated temperatures), exposure to certain pH values, exposure to certain ionic strength values, and the like, and any combination thereof. Accordingly, after the particulate-stabilized emulsion is placed at a desired location downhole or after the elapse of a particular time period (e.g., taking into account pumping time and the location of the zone of interest in a subterranean formation), the particulate-stabilized emulsion is destabilized to release the surfactant from the internal phase surfactant droplets.

As discussed above, in some embodiments, the particulates may be composed of a mineral-containing material, wherein the mineral-containing mineral comprises a mineral including, but not limited to, a silicate mineral, a native element mineral, a sulfide mineral, an arsenide mineral, an antimonide mineral (e.g., breithauptite), a telluride mineral, a sulfarsenide mineral, a sulfosalt mineral, an oxide mineral, a halide mineral, a carbonate mineral, a sulfate mineral, a phosphate mineral, a clay mineral, a mica mineral, feldspar mineral, a quartz mineral, a rare earth mineral, a zeolite mineral, a bauxite mineral, a beryllium mineral, a chromite mineral, a cobalt mineral, a fluorspar mineral, a gallium mineral, an iron ore mineral, a lithium mineral, a manganese mineral, a molybdenum mineral, a perlite mineral, a tungsten mineral, a uranium mineral, a vanadium mineral, and the like, and any combination thereof.

Suitable silicate minerals for use in the mineral-containing material forming the particulates of the present disclosure may include, but are not limited to, neosilicates, orthosilicates, sorosilicates, cyclosilicates, single-chain inosilicates, double-chain inosilicates, phyllosilicates, tectosilicates, and the like, and any combination thereof. Suitable native element minerals may include, but are not limited to, aluminum, antimony, arsenic, bismuth, carbon, cadmium, chromium, copper, gold, indium, iron, iridium, lead, mercury, nickel, osmium, palladium, platinum, rhenium, rhodium, selenium, silver, silicon, sulfur, tantalum, tellurium, tin, titanium, vanadium, zinc, and the like, and any combination thereof. Suitable sulfide minerals may include, but are not limited to, galena, pyrite, chalcopyrite, pyrrhotite, cinnabar, molybdenite, acanthitite, chalcocite, bornite, sphalerite, millerite, pentlandite, covellite, realgar, orpiment, stibnite, marcasite, and the like, and any combination thereof.

Arsenide minerals suitable for use in the mineral-containing materials forming the particulates described herein may include, but are not limited to, nickeline, skutterudite, and the like, and any combination thereof. Suitable telluride minerals for use as a mineral in the mineral-containing materials described herein may include, but are not limited to, altaite, calaverite, sylvanite, and the like, and any combination thereof. Suitable sulfarsenide minerals may include, but are not limited to cobaltite, arsenopyrite, gersdorffite, and any combination thereof. Suitable sulfosalt minerals may include, but are not limited to, jamesonite, pyrargyrite, tetrahedrite, tennantite, bournonite, enargite, proustite, cylindrite, and the like, and any combination thereof.

Suitable oxide minerals may include, but are not limited to, those with the general formula of XO, X₂O, X₂O₃, XO₂, and/or XY₂O₄, where X and Y are metal ions and O is oxygen. Specific examples of such oxide minerals may include, but are not limited to, cuprite, periclase, hematite, ilmenite, chromite, pyrolusite, magnetite, manganosite, zincite, bromellite, litharge, tenorite, corumdum, tenorite, rutile, cassiterite, baddeleyite, uraninite, thorianite, spinel, franklinite, columbite, chrysoberyl gahnite, and the like, and any combination thereof. Suitable halide minerals may include, but are not limited to, halite, fluorite, bararite, sylvite, chlorargyrite, bromargyrite, atacamite, bischofite, carnallite, cryolite, cryptohalite, and the like, and any combination thereof.

Carbonate minerals for use as the mineral in the mineral-containing material forming the particulates described herein may include, but are not limited to, calcium carbonate, sodium carbonate, magnesium carbonate, iron (II) carbonate, nickel carbonate, cadmium carbonate, manganese carbonate, zinc carbonate, cobalt carbonate, lead carbonate, strontium carbonate, barium carbonate, and the like, and any combination thereof. Other suitable carbonate minerals may include, but are not limited to, dolomite, malachite, azurite, ankerite, huntite, minrecordite, barytocite, hydrocerussite, rosasite, phosgenite, hydrozincite, auichalcite, hydromagnesite, ikaite, lansfordite, natron, monohydrocalcite, zellerite, and the like, and any combination thereof.

Suitable sulfate minerals may include, but are not limited to, barite, gypsum, celestite, anglesite, anhydrite, hanksite, chalcanthite, kieserite, starkeyite, hexahydrite, epsomite, meridianite, melanterite, antlerite, brochantite, alunite, jarosite, and the like, and any combination thereof. Suitable phosphate minerals may include, for example, minerals containing a phosphate anion (PO₄³⁻) with a freely substituting arsenate (AsO₄³⁻), vanadate (V O₄³), chlorine (Cl⁻), fluorine (F⁻), or hydroxide (OH⁻). Clay minerals for use as the mineral in the mineral-containing material forming the particulates described herein may include, but are not limited to, talc, kaolinite, illite, montmorillonite, halloysite, vermiculite, sepiolite, palygorskite, pyropyllite, and the like, and any combination thereof. Suitable mica minerals may include, but are not limited to, phlogopite, margarite, glauconite, lepidolite, muscovite, biotite, and the like, and any combination thereof. Suitable feldspar minerals may include, but are not limited to, orthoclase, sanidine, microcline, anorthoclase, albite, oligoclase, andesine, labradorite, bytownite, anorthite, and the like, and any combination thereof.

Quartz minerals for use as the mineral in the mineral-containing material forming the particulates described herein may include, but are not limited to, silicon dioxide, coesite, cristobalite, tridymite, and the like, and any combination thereof. Suitable rare earth metals may include, but are not limited to, lanthanum, cerium, praseodymium, neodymium, promethium, samarium, europium, gadolinium, terbium, dysprosium, holmium, erbium, thulium ytterbium, lutetium, and the like, and any combination thereof. Suitable zeolite minerals may include, but are not limited to, analcime, natrolite, chabazite, clinoptilolite, heulandite, natrolite, phillpsite, stibnite, mesolite, leucite, amicite, ferrierite, erionite, laumonite, mordenite, wairakite, and the like, and any combination thereof.

In some embodiments, the particulates, in addition to comprising a mineral-containing material, may also comprise degradable particulates. The degradable particulates may be used to fine-tune the destabilization of the particulate-stabilized emulsion at a particular time or upon encountering a particular stimulus (e.g., a particular temperature, pressure, salinity, and the like), such that the surfactant is released in a controlled fashion. That is, an operator may be able to use the degradable particulates, in conjunction with the mineral-containing material particulates to customize the release of the surfactant from the internal phase surfactant droplets in the particulate-stabilized emulsion for a particular subterranean formation operation, such that the release occurs at or near a zone of interest in the subterranean formation, for example.

In some embodiments, the degradable particulates may be formed from a degradable material including, but not limited to, a degradable polymer, a dehydrated salt, and any combination thereof.

A polymer may be considered “degradable,” as used herein, if the degradation is due, in situ, to a chemical and/or radical process, such as hydrolysis or oxidation. The degradability of a degradable polymer may depend, at least in part, on its backbone structure. For instance, the presence of hydrolyzable and/or oxidizable linkages in the backbone may yield a material that will degrade as described herein. The rates at which such degradable polymers degrade may be dependent on, at least, the type of repetitive unit, composition, sequence, length, molecular geometry, molecular weight, morphology (e.g., crystallinity, size of spherulites, and orientation), hydrophilicity, hydrophobicity, surface area, and additives. Also, the environment to which the degradable polymer is subjected may affect how it degrades (e.g., formation temperature, presence of moisture, oxygen, microorganisms, enzymes, pH, and the like). These factors may permit an operator to design a particulate-stabilized emulsion that is customized to release surfactant from the internal phase surfactant droplets at a desired time and/or location, and the like, within a subterranean formation.

Suitable degradable polymers may include oil-degradable polymers. Oil-degradable polymers that may be used as particulates in the particulate-stabilized emulsions described herein may be either natural or synthetic degradable polymers. The use of oil-degradable polymers as the particulates in the particulate-stabilized emulsions may be useful, for example, for maintaining the integrity of the particulate-stabilized emulsion, and thus the internal phase surfactant droplets, until produced oil begins to flow in a subterranean formation, provided other potentially destabilizing factors (e.g., temperature, pressure, and the like) are accounted for. Examples of suitable oil-degradable polymers for use as particulates in the particulate-stabilized emulsions described herein may include, but are not limited to, a polyacrylic, a polyamide, a polyolefin (e.g., polyethylene, polypropylene, polyisobutylene, polystyrene, and the like), and any combination thereof. Other suitable oil-degradable polymers may include those that have a melting point which is such that the polymer will melt or dissolve at the temperature of the subterranean formation in which it is placed, such as a wax material.

Other suitable examples of degradable polymers that may be used as particulates in the particulate-stabilized emulsions described herein may include, but are not limited to, a polysaccharide (e.g., dextran, cellulose, and the like), a chitin, a chitosan, a protein, an aliphatic polyester, a poly(lactide), a poly(glycolide), a poly(ε-caprolactone), a poly(hydroxybutyrate), a poly(anhydride), an aliphatic polycarbonate, an aromatic polycarbonate, a poly(orthoester), a poly(amino acid), a poly(ethylene oxide), a polyphosphazene, and any combination thereof.

As an example, the degradable polymers poly(anhydrides) may be used to demonstrate the ability of an operator to fine-tune the destabilization of the particulate-stabilized emulsions described herein to at least partially customize when or at what location the surfactant is released from the internal phase surfactant droplets. Poly(anhydride) hydrolysis proceeds, in situ, via free carboxylic acid chain-ends to yield carboxylic acids as final degradation products. The degradation time may be varied over a broad range by changes in the polymer backbone, which permit time controlled degradation for release of the surfactant from the internal phase surfactant droplets of the particulate-stabilized emulsions described herein. Examples of suitable poly(anhydrides) may include, but are not limited to, a poly(adipic anhydride), a poly(suberic anhydride), a poly(sebacic anhydride), a poly(dodecanedioic anhydride), a poly(maleic anhydride), a poly(benzoic anhydride), and any combination thereof.

Dehydrated salts may also be used as degradable particulates for use in the particulate-stabilized emulsions. A dehydrated salt may be suitable if it will degrade over time as it hydrates. For example, a particulate solid anhydrous borate material that degrades over time may be suitable. Specific examples of particulate solid anhydrous borate materials may include, but are not limited to, an anhydrous sodium tetraborate (also known as anhydrous borax), an anhydrous boric acid, and any combination thereof. These anhydrous borate materials are only slightly soluble in water. However, with time and heat in a subterranean environment, the anhydrous borate materials may react with the surrounding aqueous fluid and hydrate. The resulting hydrated borate materials are highly soluble in water as compared to anhydrous borate materials. In some instances, the total time required for the anhydrous borate materials to degrade in the presence of an aqueous fluid may be in the range of from a lower limit of about 8 hours (hr), 12 hr, 16 hr, 20 hr, 24 hr, 28 hr, 32 hr, 36 hr, and 40 hr, to about 72 hr, 68 hr, 64 hr, 60 hr, 56 hr, 52 hr, 48 hr, 44 hr, and 40 hr, encompassing any value and subset therebetween, depending upon the temperature of the subterranean zone in which they are in contact. Each of these is critical to the embodiments described herein, and the time for degradation may depend on the particular subterranean formation operation being performed, the composition and geometry (e.g., depth) of the subterranean formation, and the like. Other examples of dehydrated salts may include, but are not limited to, organic or inorganic salts like acetate trihydrate.

Blends of certain degradable materials may also be suitable as degradable particulates. One example of a suitable blend of materials is a mixture of poly(lactic acid) and sodium borate where the mixing of an acid and base could result in a neutral solution where this is desirable. Another example would include a blend of poly(lactic acid) and boric oxide.

In some embodiments, the particulates (referred to herein as collectively the mineral-containing material particulates and the degradable particulates, unless specifically stated otherwise) may be present in the particulate-stabilized emulsion in an amount that does not result in an excessively thickened emulsion, where such high viscosity may result in poor injectability, poor cold weather handling, and the like, and any combination thereof. In some embodiments, accordingly, the particulates may be present in the particulate-stabilized emulsion in an amount in the range of a lower limit of about 0.01%, 0.05%, 0.1%, 0.5%, 1%, 1.5%, 2%, 2.5%, 3%, 3.5%, 4%, 4.5%, 5%, 5.5%, 6%, 6.5%, and 7% to an upper limit of about 20%, 19.5%, 19%, 18.5%, 18%, 17.5%, 17%, 16.5%, 16%, 15.5%, 15%, 14.5%, 14%, 13.5%, 13%, 12.5%, 12%, 11.5%, 11%, 10.5%, 10%, 9.5%, 9%, 8.5%, 8%, 7.5%, and 7% by weight of the particulate-stabilized emulsion, encompassing any value and subset therebetween. Each of these is critical to the embodiments described herein, and the amount of particulates included in the particulate-stabilized emulsion may depend on the desired viscosity, the type of surfactant, the desired amount of surfactant, the desired stability time before destabilization of the internal phase surfactant droplets, the particular subterranean formation operation, the composition of the particular subterranean formation being treatment, and the like.

In those embodiments where degradable particulates form a portion of the particulates in the particulate-stabilized emulsion, in addition to the mineral-containing material particulates, the degradable particulates may be present in an amount in the range of a lower limit of about 0.001%, 0.01%, 0.1%, 1%, 10%, 20%, and 30% to an upper limit of about 90%, 80%, 70%, 60%, 50%, 40%, and 30% by weight of the total amount of particulates in the particulate-stabilized emulsion, encompassing any value and subset therebetween. Each of these is critical to the embodiments described herein, and the amount of degradable particulates in the particulate-stabilized emulsion by volume may depend on the length of time before destabilization is desired, the composition and geometry of the subterranean formation, the conditions of the subterranean formation (e.g., temperature), and the like.

The particulates suitable for use in the particulate-stabilized emulsion described herein may be of any shape, provided that they are able to maintain the integrity of the internal phase surfactant droplets therein. For example, in some embodiments, the particulates may be preferably substantially spherical in shape. In other embodiments, it may be desirable to use substantially non-spherical particulates. Suitable substantially non-spherical particulates may be, for example, cubic, polygonal, fibrous, or any other non-spherical shape. Such substantially non-spherical proppant particulates may be, for example, cubic-shaped, rectangular-shaped, rod-shaped, ellipse-shaped, cone-shaped, pyramid-shaped, platelet-shaped, or cylinder-shaped, either alone or in combination with one another. That is, in embodiments wherein the proppant particulates are substantially non-spherical, the aspect ratio of the material may range such that the material is fibrous to such that it is cubic, octagonal, or any other configuration. Combinations of substantially spherical and substantially non-spherical particulate may also be suitable, without departing from the scope of the present disclosure. The use of substantially spherical and/or substantially non-spherical particulates may depend on the material composition of the particulates, the processing of the particulates, and the like.

In some embodiments, for example, the particulates chosen for use in the particulate-stabilized emulsion may be a clay mineral, which is capable of forming a platelet-shape (also referred to as a “house of cards” shape) with other of the clay particulates, which may provide additional stability and/or strength to the internal phase surfactant droplets in the particulate-stabilized emulsion.

The size of the particulates for use in the particulate-stabilized emulsions of the present disclosure are necessarily smaller in size that the internal phase surfactant droplets, as the particulates surround the internal phase surfactant to form the internal phase surfactant droplets. In some embodiments, the particulates may be sized such that they are micro-sized, nano-sized, and any combination thereof. The micro-sized particulates may be sized such that they have an average particle size in an amount in the range of a lower limit of about 1 micrometer (μm), 5 μm, 10 μm, 15 μm, 20 μm, 25 μm, 30 μm, 35 μm, 40 μm, 45 μm, and 50 μm to an upper limit of about 100 μm, 95 μm, 90 μm, 85 μm, 80 μm, 75 μm, 70 μm, 65 μm, 60 μm, 55 μm, and 50 μm, encompassing any value and subset therebetween. The nano-sized particulates may be sized such that they have an average particle size in an amount in the range of a lower limit of about 1 nanometer (nm), 50 nm, 100 nm, 150 nm, 200 nm, 250 nm, 300 nm, 350 nm, 400 nm, 450 nm, and 50 nm to an upper limit of about 1000 nm, 950 nm, 900 nm, 850 nm, 800 nm, 750 nm, 700 nm, 650 nm, 600 nm, 550 nm, and 500 nm, encompassing any value and subset therebetween. As described below, each of these sizes is critical to the embodiments of the present disclosure and their combination may be used to fine-tune the destabilization of the internal phase surfactant droplets in the particulate-stabilized emulsion for placement of a surfactant at a desired location in a subterranean formation, as discussed below.

The combination of micro-sized and nano-sized particulates may also be suitable for use in forming the particulate-stabilized emulsions of the present disclosure. For example, in some embodiments, greater than at least about 50% of the particulates are nano-sized. The use of micro-sized particulates may be particularly useful in stabilizing large internal phase surfactant droplets, such as those greater than about 1 millimeter (mm).

The external phase of the particulate-stabilized emulsions of the present disclosure may comprise a base fluid selected from the group consisting of an aqueous base fluid, an oil base fluid, a supercritical fluid, and any combination thereof. Suitable aqueous base fluids may include, but are not limited to, fresh water, saltwater (e.g., water containing one or more salts dissolved therein), brine (e.g., saturated salt water), seawater, and any combination thereof. Suitable oil base fluids may include, but are not limited to, alkanes, olefins, aromatic organic compounds, cyclic alkanes, paraffins, diesel fluids, mineral oils, desulfurized hydrogenated kerosenes, and any combination thereof. As used herein, the term “supercritical fluid” refers to any substance at a temperature and pressure above its critical point, where distinct liquid and gas phases do not exist. Suitable supercritical fluids may include any of the aqueous base fluids and/or oil base fluids in a supercritical state. Other suitable supercritical fluids may include, but are not limited to, supercritical carbon dioxide, supercritical nitrogen dioxide, supercritical nitrogen, supercritical ammonia, supercritical proppant, supercritical butane, and the like, and any combination thereof.

The internal phase surfactant of the particulate-stabilized emulsions described herein may include, but are not limited to, a non-ionic surfactant, an anionic surfactant, a cationic surfactant, a zwitterionic surfactant, and any combination thereof. The surfactants may exhibit viscoelastic properties, without departing from the scope of the present disclosure.

Suitable non-ionic surfactants may include, but are not limited to, an alkyoxylate (e.g., an alkoxylated nonylphenol condensate, such as poly(oxy-1,2-ethanediyl), alpha-(4-nonylphenyl)-omega-hydroxy-,branched), an alkylphenol, an ethoxylated alkyl amine, an ethoxylated oleate, a tall oil, an ethoxylated fatty acid, an alkyl polyglycoside, a sorbitan ester, a methyl glucoside ester, an amine ethoxylate, a diamine ethoxylate, a polyglycerol ester, an alkyl ethoxylate, an alcohol that has been polypropoxylated and/or polyethoxylated, any derivative thereof, and any combination thereof. As used herein, the term “derivative,” refers to any compound that is made from one of the identified compounds, for example, by replacing one atom in the listed compound with another atom or group of atoms, or rearranging two or more atoms in the listed compound.

Suitable anionic surfactants may include, but are not limited to, methyl ester sulfonate, a hydrolyzed keratin, polyoxyethylene sorbitan monopalmitate, polyoxyethylene sorbitan monostearate, polyoxyethylene sorbitan monooleate, a linear alcohol alkoxylate, an alkyl ether sulfate, dodecylbenzene sulfonic acid, a linear nonyl-phenol, dioxane, ethylene oxide, polyethylene glycol, an ethoxylated castor oil, dipalmitoyl-phosphatidylcholine, sodium 4-(1′ heptylnonyl)benzenesulfonate, polyoxyethylene nonyl phenyl ether, sodium dioctyl sulphosuccinate, tetraethyleneglycoldodecylether, sodium octylbenzenesulfonate, sodium hexadecyl sulfate, sodium laureth sulfate, ethylene oxide, decylamine oxide, dodecylamine betaine, dodecylamine oxide, any derivative thereof, or any combination thereof.

Suitable cationic surfactants may include, but are not limited to, a trimethylcocoammonium chloride, a trimethyltallowammonium chloride, a dimethyldicocoammonium chloride, a bis(2-hydroxyethyl)tallow amine, a bis(2-hydroxyethyl)erucylamine, a bis(2-hydroxyethyl)coco-amine, a cetylpyridinium chloride, an arginine methyl ester, an alkanolamine, an alkylenediamide, an alkyl ester sulfonate, an alkyl ether sulfonate, an alkyl ether sulfate, an alkali metal alkyl sulfate, an alkyl sulfonate, an alkylaryl sulfonate, a sulfosuccinate, an alkyl disulfonate, an alkylaryl disulfonate, an alkyl disulfate, an alcohol polypropoxylated sulfate, an alcohol polyethoxylated sulfate, a taurate, an amine oxide, an alkylamine oxide, an ethoxylated amide, an alkoxylated fatty acid, an alkoxylated alcohol (e.g., lauryl alcohol ethoxylate, ethoxylated nonyl phenol), an ethoxylated fatty amine, an ethoxylated alkyl amine (e.g., cocoalkylamine ethoxylate), a betaine, a modified betaine, an alkylamidobetaine (e.g., cocoamidopropyl betaine), a quaternary ammonium compound (e.g., trimethyltallowammonium chloride, trimethylcocoammonium chloride), any derivative thereof, and any combination thereof.

Suitable zwitterionic surfactants may include, but are not limited to, an alkyl amine oxide, an alkyl betaine, an alkyl amidopropyl betaine, an alkyl sulfobetaine, an alkyl sultaine, a dihydroxyl alkyl glycinate, an alkyl ampho acetate, a phospholipid, an alkyl aminopropionic acid, an alkyl imino monopropionic acid, an alkyl imino dipropionic acid, and any combination thereof.

As example, surfactants that may exhibit viscoelastic properties may include, but are not limited to, a sulfosuccinate, a taurate, an amine oxide (e.g., an amidoamine oxide), an ethoxylated amide, an alkoxylated fatty acid, an alkoxylated alcohol, an ethoxylated fatty amine, an ethoxylated alkyl amine, a betaine, modified betaine, an alkylamidobetaine, a quaternary ammonium compound, an alkyl sulfate, an alkyl ether sulfate, an alkyl sulfonate, an ethoxylated ester, an ethoxylated glycoside ester, an alcohol ether, any derivative thereof, and any combination thereof.

In forming the particulate-stabilized emulsion, as an example, the external phase and the internal phase may first be mixed together. The internal phase (surfactant) should be soluble or substantially soluble in the external phase. Thereafter, the desired particulates are included into the mixture of the internal phase and the external phase. The particulates may be distributed and wetted in the mixture followed by strong mixing energy to build a good emulsion distribution. With the application of such high shear, the particulate-stabilized emulsion comprising the internal phase surfactant droplets may then be formed. Such high shear mixing may be achieved using batch mixing or inline mixing (i.e., positioned in a flowing stream) and may utilize a high shear rotor/stator mixer, without departing from the scope of the present disclosure. In some embodiments, the high shear mixing may be performed in order to achieve homogenization required to generate the particulate-stabilized emulsions described herein. In some embodiments, the high shear mixing may be performed in the range of a lower limit of about 900 revolutions per minute (rmp), 2000 rpm, 3000 rpm, 4000 rpm, 5000 rpm, 6000 rpm, 7000 rpm, 8000 rpm, 9000 rpm, 10000 rpm, 11000 rpm, 12000 rpm, and 13000 to an upper limit of about 25000 rpm, 24000 rpm, 23000 rpm, 22000 rpm, 21000 rpm, 20000 rpm, 19000 rpm, 18000 rpm, 17000 rpm, 16000 rpm, 15000 rpm, 14000 rpm, and 13000 rpm, encompassing any value and subset therebetween. The criticality of each high shear mixing speed may depend on a number of factors including, but not limited to, the composition of the particulate-stabilized emulsion, and the like.

In some embodiments, the particulate-stabilized emulsion may further comprise an emulsifier. The emulsifier may serve to further stabilize the internal phase surfactant droplets in the particulate-stabilized emulsion. The emulsifier may be added to the particulate-stabilized emulsion after it has formed such that the emulsifier does not invade the internal phase surfactant droplets but congregates around the droplets, sharing the interface between the external phase and the internal phase with the particulates. Accordingly, in some embodiments, the emulsifier may be any of the surfactants that may be used as the surfactants in the particulate-stabilized emulsion of the present disclosure. In other embodiments, the emulsifier may be selected from the group consisting of a polyolefin amide, an alkenamide, and any combination thereof.

In some embodiments, the emulsifier may be present in the particulate-stabilized emulsions of the present disclosure in an amount in the range of a lower limit of about 0.01%, 0.05%, 0.1%, 0.5%, 1%, 1.25%, 1.5%, 1.75%, and 2% to an upper limit of about 5%, 4.75%, 4.5%, 4.25%, 4%, 3.75%, 3.5%, 3.25%, 3%, 2.75%, 2.5%, 2.25%, and 2% by weight of the particulate-stabilized emulsion, encompassing any value and subset therebetween. Each of these values is critical to the embodiments of the present invention and the amount of emulsifier may depend on a number of factors, including the composition of the particulate-stabilized emulsion, the desired stability of the particulate-stabilized emulsion, and the like, and any combination thereof.

In some embodiments, the particulate-stabilized emulsions of the present disclosure may be delivered to a downhole location alone. In other embodiments, the particulate-stabilized emulsion may be delivered to a downhole location in addition to or in a mixture with a solvent. In yet other embodiments, the surfactant in the internal phase surfactant droplets may further comprise a surfactant-additive including, but not limited to, an amine, an alcohol, a glycol, an organic salt, a chelating agent, a solvent, a mutual solvent, an organic acid, an organic acid salt, an inorganic salt, an oligomer, a polymer, a copolymer, and any combination thereof. In some embodiments, such surfactant-additives may be included in the internal phase surfactant droplets in the range of a lower limit of about 0.01%, 0.1%, 0.5%, 1%, 1.5%, 2%, 2.5%, 3%, 3.5%, 4%, and 4.5% to an upper limit of 10%, 9.5%, 9%, 8.5%, 8%, 7.5%, 7%, 6.5%, 6%, 5.5%, 5%, and 4.5% by weight of the internal phase surfactant droplets, encompassing any value and subset therebetween.

In yet other embodiments, the internal phase or the external phase of the particulate-stabilized emulsion of the present disclosure may further comprise an emulsion-additive including, but not limited to, a salt, a weighting agent, an inert solid, a fluid loss control agent, an emulsifier, a dispersion aid, a corrosion inhibitor, an emulsion thinner, an emulsion thickener, a viscosifying agent, a gelling agent, a surfactant, a particulate, a proppant, a gravel particulate, a lost circulation material, a foaming agent, a gas, a pH control additive, a breaker, a biocide, a crosslinker, a stabilizer, a chelating agent, a scale inhibitor, a gas hydrate inhibitor, a mutual solvent, an oxidizer, a reducer, a friction reducer, a clay stabilizing agent, and any combination thereof.

In various embodiments, systems configured for delivering the particulate-stabilized emulsions described herein to a downhole location are described. In various embodiments, the systems may comprise a pump fluidly coupled to a tubular, the tubular containing the particulate-stabilized emulsion described herein.

The pump may be a high pressure pump in some embodiments. As used herein, the term “high pressure pump” will refer to a pump that is capable of delivering a fluid (e.g., the particulate-stabilized emulsion) downhole at a pressure of about 1000 psi or greater. A high pressure pump may be used when it is desired to introduce the particulate-stabilized emulsions to a subterranean formation at or above a fracture gradient of the subterranean formation, but it may also be used in cases where fracturing is not desired. Suitable high pressure pumps may include, but are not limited to, floating piston pumps, positive displacement pumps, and the like.

In other embodiments, the pump may be a low pressure pump. As used herein, the term “low pressure pump” will refer to a pump that operates at a pressure of about 1000 psi or less. In some embodiments, a low pressure pump may be fluidly coupled to a high pressure pump that is fluidly coupled to the tubular. That is, in such embodiments, the low pressure pump may be configured to convey the particulate-stabilized emulsions to the high pressure pump. In such embodiments, the low pressure pump may “step up” the pressure of the particulate-stabilized emulsions before reaching the high pressure pump.

In some embodiments, the systems described herein may further comprise a mixing tank that is upstream of the pump and in which the particulate-stabilized emulsions are formulated. In various embodiments, the pump (e.g., a low pressure pump, a high pressure pump, or a combination thereof) may convey the particulate-stabilized emulsions from the mixing tank or other source of the particulate-stabilized emulsions to the tubular. In other embodiments, however, the particulate-stabilized emulsions may be formulated offsite and transported to a worksite, in which case the particulate-stabilized emulsions may be introduced to the tubular via the pump directly from its shipping container (e.g., a truck, a railcar, a barge, or the like) or from a transport pipeline. In either case, the particulate-stabilized emulsions may be drawn into the pump, elevated to an appropriate pressure, and then introduced into the tubular for delivery downhole.

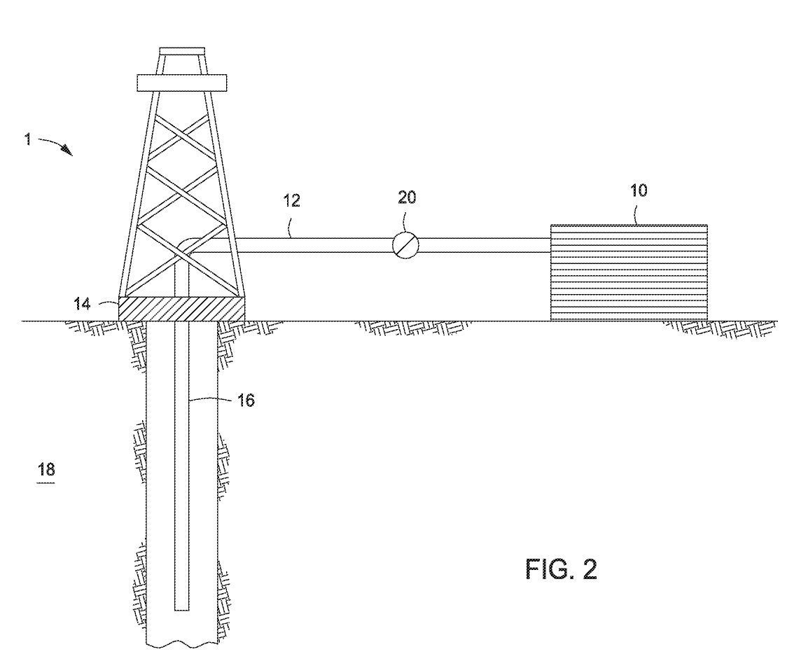

FIG. 2 shows an illustrative schematic of a system that can deliver the particulate-stabilized emulsion of the present disclosure to a downhole location, according to one or more embodiments. It should be noted that while FIG. 2 generally depicts a land-based system, it is to be recognized that like systems may be operated in subsea locations as well. As depicted in FIG. 2, system 1 may include mixing tank 10, in which the particulate-stabilized emulsions of the embodiments herein may be formulated. The particulate-stabilized emulsions may be conveyed via line 12 to wellhead 14, where the particulate-stabilized emulsions enter tubular 16, tubular 16 extending from wellhead 14 into subterranean formation 18. Upon being ejected from tubular 16, the particulate-stabilized emulsions may subsequently penetrate into subterranean formation 18. Pump 20 may be configured to raise the pressure of the particulate-stabilized emulsions to a desired degree before introduction into tubular 16. It is to be recognized that system 1 is merely exemplary in nature and various additional components may be present that have not necessarily been depicted in FIG. 2 in the interest of clarity. Non-limiting additional components that may be present may include, but are not limited to, supply hoppers, valves, condensers, adapters, joints, gauges, sensors, compressors, pressure controllers, pressure sensors, flow rate controllers, flow rate sensors, temperature sensors, and the like.

Although not depicted in FIG. 2, a portion of the particulate-stabilized emulsions may, in some embodiments, flow back to wellhead 14 and exit subterranean formation 18. The portion of the particulate-stabilized emulsion that may flow back may be after destabilization of the internal phase surfactant droplets and, thus, may include the external phase, the particulates, any emulsifier or other additives, and, in some instances, residual surfactant. In some embodiments, the particulate-stabilized emulsion that has flowed back to wellhead 14 may subsequently be recovered, reformulated, and/or recirculated to subterranean formation 18 as a particulate-stabilized emulsion or for use as another treatment fluid for use in a subterranean formation operation.

It is also to be recognized that the disclosed particulate-stabilized emulsions may also directly or indirectly affect the various downhole equipment and tools that may come into contact therewith during operation. Such equipment and tools may include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like. Any of these components may be included in the systems generally described above and depicted in FIG. 2.

Embodiments disclosed herein include:

### Embodiment A

A method comprising: introducing a particulate-stabilized emulsion into a subterranean formation having a mineralogy profile, wherein the particulate-stabilized emulsion comprises: an external phase, an internal phase comprising a surfactant, and particulates at an interface between the internal phase and the external phase, thereby forming internal phase surfactant droplets surrounded with the particulates and suspended within the external phase, wherein at least a portion of the particulates are composed of a mineral-containing material selected to mimic at least a portion of the mineralogy profile of the subterranean formation; and destabilizing the particulate-stabilized emulsion to release the surfactant from the internal phase surfactant droplets.

### Embodiment B

A system comprising: a tubular extending into a wellbore in a subterranean formation having a mineralogy profile; and a pump fluidly coupled to the tubular, the tubular containing a particulate-stabilized comprising: an external phase, an internal phase comprising a surfactant, and particulates at an interface between the internal phase and the external phase, thereby forming internal phase surfactant droplets surrounded with the particulates and suspended within the external phase, wherein at least a portion of the particulates are composed of a mineral-containing material selected to mimic at least a portion of the mineralogy profile of the subterranean formation.

Each of Embodiment A and Embodiment B may have one or more of the following additional elements in any combination:

Element 1: Wherein the mineral-containing material comprises at a mineral selected from the group consisting of a silicate mineral, a native element mineral, a sulfide mineral, an arsenide mineral, an antimonide mineral, a telluride mineral, a sulfarsenide mineral, a sulfosalt mineral, an oxide mineral, a halide mineral, a carbonate mineral, a sulfate mineral, a phosphate mineral, a clay mineral, a mica mineral, feldspar mineral, a quartz mineral, a rare earth mineral, a zeolite mineral, a bauxite mineral, a beryllium mineral, a chromite mineral, a cobalt mineral, a fluorspar mineral, a gallium mineral, an iron ore mineral, a lithium mineral, a manganese mineral, a molybdenum mineral, a perlite mineral, a tungsten mineral, a uranium mineral, a vanadium mineral, and any combination thereof.

Element 2: Wherein the particulates further comprise a degradable material.

Element 3: Wherein the particulates further comprise a degradable material, and wherein the degradable material is selected from the group consisting of a degradable polymer, a dehydrated salt, and any combination thereof.

Element 4: Wherein the subterranean formation is a carbonate formation and at least a portion of the particulates are composed of calcium carbonate.

Element 5: Wherein the subterranean formation is a siliceous formation and at least a portion of the particulates are composed of silicon dioxide.

Element 6: Wherein the particulates are micro-sized, nano-sized, and any combination thereof.

Element 7: Wherein the particulates are micro-sized, nano-sized, and any combination thereof, and wherein the micro-sized particulates have an average particulate size in the range of about 1 μm to about 100 μm.

Element 8: Wherein the particulates are micro-sized, nano-sized, and any combination thereof, and wherein the nano-sized particulates have an average particulate size in the range of about 1 nm to about 1000 nm.

Element 9: Wherein the particulates are present in the particulate-stabilized emulsion in an amount in the range of about 0.01% to about 15% by weight of the particulate-stabilized emulsion.

Element 10: Wherein the internal phase surfactant droplets are present in an amount in the range of about 0.01% to about 80% by volume of the particulate-stabilized emulsion.

Element 11: Wherein the particulate-stabilized emulsion further comprises an emulsifier.

Element 12: Wherein the particulate-stabilized emulsion further comprises an emulsifier, and wherein the emulsifier is present in the particulate-stabilized emulsion in an amount in the range of about 0.01% to about 5% by weight of the particulate-stabilized emulsion.

Element 13: Wherein the surfactant is selected from the group consisting of a non-ionic surfactant, an anionic surfactant, a cationic surfactant, a zwitterionic surfactant, and any combination thereof.

Element 14: Wherein the external phase comprises a base fluid selected from the group consisting of an aqueous base fluid, an oil base fluid, a supercritical fluid, and any combination thereof.

By way of non-limiting example, exemplary element combinations applicable to Embodiment A and/or Embodiment B include: 1, 2, 3, 4, 5, 6, 7, 8, 9, 10, 11, 12, and 13; 1 and 3; 1, 4, 6, and 13; 3, 9, and 10; 6 and 7; 4, 5, 10, and 12; 4 and 11; 2, 5, 9, 10, 11, and 12; 5 and 7; 8, and 13; and the like.

Therefore, the present disclosure is well adapted to attain the ends and advantages mentioned as well as those that are inherent therein. The particular embodiments disclosed above are illustrative only, as they may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

The invention claimed is:

1. A method comprising:
introducing a particulate-stabilized emulsion into a subterranean formation having a mineralogy profile,
wherein the particulate-stabilized emulsion comprises:
an external phase,
an internal phase comprising a surfactant, and
particulates at an interface between the internal phase and the external phase, thereby forming internal phase surfactant droplets surrounded with the particulates and suspended within the external phase,
wherein at least a portion of the particulates are composed of a mineral-containing material selected to mimic at least a portion of the mineralogy profile of the subterranean formation; and
destabilizing the particulate-stabilized emulsion to release the surfactant from the internal phase surfactant droplets.

2. The method of claim 1, wherein the mineral-containing material comprises at a mineral selected from the group consisting of a silicate mineral, a native element mineral, a sulfide mineral, an arsenide mineral, an antimonide mineral, a telluride mineral, a sulfarsenide mineral, a sulfosalt mineral, an oxide mineral, a halide mineral, a carbonate mineral, a sulfate mineral, a phosphate mineral, a clay mineral, a mica mineral, feldspar mineral, a quartz mineral, a rare earth mineral, a zeolite mineral, a bauxite mineral, a beryllium mineral, a chromite mineral, a cobalt mineral, a fluorspar mineral, a gallium mineral, an iron ore mineral, a lithium mineral, a manganese mineral, a molybdenum mineral, a perlite mineral, a tungsten mineral, a uranium mineral, a vanadium mineral, and any combination thereof.

3. The method of claim 1, wherein the particulates further comprise a degradable material.

4. The method of claim 3, wherein the degradable material is selected from the group consisting of a degradable polymer, a dehydrated salt, and any combination thereof.

5. The method of claim 1, wherein the subterranean formation is a carbonate formation and at least a portion of the particulates are composed of calcium carbonate.

6. The method of claim 1, wherein the subterranean formation is a siliceous formation and at least a portion of the particulates are composed of silicon dioxide.

7. The method of claim 1, wherein the particulates are micro-sized, nano-sized, and any combination thereof.

8. The method of claim 7, wherein the micro-sized particulates have an average particulate size in the range of about 1 μm to about 100 μm.

9. The method of claim 7, wherein the nano-sized particulates have an average particulate size in the range of about 1 nm to about 1000 nm.

10. The method of claim 1, wherein the particulates are present in the particulate-stabilized emulsion in an amount in the range of about 0.01% to about 15% by weight of the particulate-stabilized emulsion.

11. The method of claim 1, wherein the internal phase surfactant droplets are present in an amount in the range of about 0.01% to about 80% by volume of the particulate-stabilized emulsion.

12. The method of claim 1, wherein the particulate-stabilized emulsion further comprises an emulsifier.

13. The method of claim 13, wherein the emulsifier is present in the particulate-stabilized emulsion in an amount in the range of about 0.01% to about 5% by weight of the particulate-stabilized emulsion.

14. The method of claim 1, wherein the surfactant is selected from the group consisting of a non-ionic surfactant, an anionic surfactant, a cationic surfactant, a zwitterionic surfactant, and any combination thereof.

15. The method of claim 1, wherein the external phase comprises a base fluid selected from the group consisting of an aqueous base fluid, an oil base fluid, a supercritical fluid, and any combination thereof.

16. A system comprising:
a tubular extending into a wellbore in a subterranean formation having a mineralogy profile; and
a pump fluidly coupled to the tubular, the tubular containing a particulate-stabilized comprising:
an external phase,
an internal phase comprising a surfactant, and
particulates at an interface between the internal phase and the external phase, thereby forming internal phase surfactant droplets surrounded with the particulates and suspended within the external phase,
wherein at least a portion of the particulates are composed of a mineral-containing material selected to mimic at least a portion of the mineralogy profile of the subterranean formation.

17. The system of claim 16, wherein the subterranean formation is a carbonate formation and at least a portion of the particulates are composed of calcium carbonate.

18. The system of claim 16, wherein the subterranean formation is a siliceous formation and at least a portion of the particulates are composed of silicon dioxide.

19. The system of claim 16, wherein the particulates are present in the particulate-stabilized emulsion in an amount in the range of about 0.01% to about 15% by weight of the particulate-stabilized emulsion.

20. The system of claim 16, wherein the internal phase surfactant droplets are present in an amount in the range of about 0.01% to about 80% by volume of the particulate-stabilized emulsion.
